(19) United States
(12) Patent Application Publication
(10) Pub. No.: US 2004/0252604 A1
(43) Pub. Date: Dec. 16, 2004

(54) Method and apparatus for creating an indexed playlist in a digital audio data player

(76) Inventors: Lisa Renee Johnson, Indianapolis, IN (US); Newton Galileo Guillen, Carmel, IN (US); Sin Hui Cheah, Carmel, IN (US)

Correspondence Address: Joseph S Tripoli, Thomson Multimedia Licensing Inc, PO Box 5312, Princeton, NJ, 08543-5312, US

(21) Appl. No.: 10/489,231

(22) PCT Filed: Sep. 6, 2002
(86) PCT No.: PCT/US02/28491

Related U.S. Application Data
(60) Provisional application No. 60/318,721, filed on Sep. 10, 2001.
(60) Provisional application No. 60/318,584, filed on Sep. 11, 2001.

(51) Int. Cl. G11B 5/09

(52) U.S. Cl. 369/47.22; 369/53.2

(57) ABSTRACT

A digital audio player and a method for providing audio playlist files. The audio data player comprises a DSP coupled with data storage. Data storage is a high-volume storage device such a hard drive for storing audio data files. The method provides playlist records in a playlist file for use by audio data player by locating audio data files stored on data storage, reading content information for the audio data files, determining file pointers locating the audio data files, sorting the content information and file pointers by at least a portion of the content information, determining indexing information indicating the location and number of playlist records related by content information, and storing the content information, indexing information and file pointers in playlist records in a playlist. The method includes creating a number of playlist files, each sorted by different content information such as ID3 tag information stored in MP3 files, for example, artist, album, genre, and title. Additionally, the method may be executed in a personal computer as a stand-alone application or as a plug-in used with existing music management software. Created playlists may then be transferred to an audio data player.

### BACKGROUND OF THE INVENTION

1. Field of the Invention

The present invention relates to an apparatus and a method for processing digitally encoded audio data, and in particular, to a method and apparatus for creating audio data files playlist in a digital audio data player.

2. Description of the Related Art

The use of portable audio data players capable of playing digitally encoded audio data has become commonplace. In particular, relatively small handheld devices that can process digitally encoded audio data stored on solid state memory devices have become popular. Additionally, as demand has increased for higher data storage capacity in portable audio data players, another generation of players that include miniaturized high capacity hard drives has been developed and is gaining popularity.

In an audio data player, the digital audio data is loaded into a data storage device by first downloading the data to a PC from an audio CD, the Internet, or another digital audio device. The data is then usually compressed according to a selected encoding format and loaded into the data storage device associated with the audio data player.

The audio data is decompressed/decoded by the audio data player during playback according to the selected encoding format. A variety of encoding formats for compressing and decompressing audio data is available. As used hereinafter, the term encoding format refers to any encoding/decoding scheme that specifies the syntax and semantics of a compressed bitstream and how the bitstream must be decompressed for reproduction. Such encoding formats include, but are not limited to, MP3 and MP3 Pro.

For MP3 encoded audio data files, the data file is prepended or appended with a special set of frames called an ID3 tag. The ID3 tag contains descriptive text and other data relevant to the audio data file. For example, the tag may include title, artist, album, year, comments, and genre. ID3 tag information is useful for searching, sorting, and selecting specific audio data files based on the information contained in the ID3 tag. Because ID3 tag information is often stored as textual characters, the information can be displayed on the display screen of an audio data player.

Most PC-based audio data file management programs allow the user to create and edit playlists that can then be downloaded to a portable audio data player and used for playing a select sequence of audio data files. One such form of playlist typically associated with MP3 audio data files is known as an M3U playlist. An M3U playlist consists simply of a text file containing a numbered sequential list of paths or locations of data audio files included in the playlist. Thus, a playlist created on a PC and downloaded to an audio data player may be used to selectively play a sequence of audio data files that are contained in the data storage of the audio data player. However, the M3U file format includes only the file location or path information, filename, and a comment field. Often, audio data players have relied on the audio data file filename to provide a truncated representation of information such as artist, album, genre, and title. Thus, the M3U file format does not contain other audio data file information such as the information contained in an ID3 tag of an MP3 audio data file.

PC-based audio data file management programs also allow the user to sort available audio data files by their content, such as by ID3 fields for MP3 audio data files. PCs generally have the processing power to quickly extract the content description information from the audio data files and also have the necessary memory to store this information and display it in a timely manner to the user. However, such processing power and memory is generally not practical in non-PC-based audio data players, particularly portable or hand-held players, which have limited processing power and memory. This limitation is especially acute in audio data players having high-capacity data storage that is able to store several hundred or thousand audio data files. Applications have had to repeatedly access audio data files on the audio data player to obtain ID3 tag information each time a file is displayed, causing costly, slow operation when hundreds or thousands of files are accessible. Therefore, browsing available audio data files in various sequences according to their ID3 information has not been available in non-PC-based audio data players.

### BRIEF SUMMARY OF THE INVENTION

The present invention addresses some of the above-noted limitations of audio data players, particularly handheld audio players, by providing a method of creating M3U playlists that include content and indexing information. The playlists provide browsing of audio data file content information using the indexing information to allow the user to navigate the playlist efficiently. The audio data player has a DSP coupled with data storage and an audio decoder for processing encoded audio data files and audio playlist files, and includes a user interface for allowing the user to traverse the playlist utilizing the indexing and content information.

In particular, the present invention provides an indexed data structure that is an extension of the M3U file format used to store audio playlists. The data structure according to the present invention uses an M3U comment field format to add audio content information descriptive of the content of the audio data file, and indexing information grouping and indicating the relative location of related playlist records. Content information may include, for example, ID3 tag information found in MP3 files. Additionally, the data structure may be sorted by one or more of the content information fields.

The present invention also provides a method of creating M3U audio playlists that include content and indexing information for each playlist record. The playlist files may be used by an audio data player to later access audio content information for all available audio data files in data storage without having to again access the data directly from individual audio data files. Additionally, multiple audio playlists may be created and stored, each being sorted by a different content information field, for example, artist, album, title, genre, etc. The method may be implemented by software in an audio data player or in another data device such as a personal computer. In a personal computer, the software may consist of a stand-alone executable program or a plug-in module for existing music management software.

The software, known as the Lyra Profiler application in the exemplary embodiment, may be executed in a PC that is connected to an audio data device having audio data files stored in data storage, or in an alternative embodiment, may be executed directly in the audio data player.

The present invention also provides an audio data player having a DSP, or microcontroller, coupled with data storage capable of storing audio data files, creating and storing playlist files, and having software capable of reading the playlist file records and outputting a navigable list of at least a portion of content information fields of the playlist records according to a predetermined sequence.

The audio data player generally includes a DSP, or microcontroller, coupled with a user interface, data storage, buffer memory, and an audio decoder. The user interface includes an LCD and a keyboard having various multi-way and multi-function switches. The audio data player also provides a universal serial bus (“USB”) port for connection to a PC or other USB-equipped device. By connecting the audio data player to a PC via the USB port, audio data files and audio playlists may be downloaded to the audio data player and stored into data storage. In one embodiment, the data storage comprises a 10 GB hard drive; however, other moving data storage media or solid state memory devices, such as flash memory cards, may also be used. In this embodiment, the user interface provides menu driven selection, sorting, and playback of audio data files. Additionally, during playback of an audio data file, the LCD displays ID3 tag information such as title, artist, album, and genre. The LCD screen may also display other information such as elapsed playback time, volume level, and preset DSP mode.

The disclosed embodiment of the audio data player is a portable handheld unit having a rechargeable battery, 5 volt DC input, headphones output port, and line out port. Therefore, the audio data player may be used for portable applications using headphones, or for fixed applications using AC power and headphones or another audio device.

In one form thereof, software stored in a computer-readable medium is disclosed, the software capable of creating a sorted playlist of audio data file records and having modules for: creating the sorted playlist, the modules locating audio data files stored on at least one data storage device, the audio data files having content information descriptive of the content of the audio data file; reading content information fields for the audio data files; determining file pointer fields locating the audio data fields; sorting the file pointer fields by at least one of the content information fields; determining indexing information fields indicating at least one of the location and number of records related by at least one of the content information fields; and storing the indexing information fields in the playlist records.

In another form thereof, a method is disclosed for providing playlist records in an audio data player, the records providing descriptive content information about audio data files, the audio data files having content information descriptive of the content of the audio data file, locating audio data files stored on at least one data storage device; reading the content information fields of the audio data files; determining file pointer fields locating the audio data fields; determining indexing information fields indicating at least one of the location and number of playlist records related by at least one of the content information fields; storing the index information fields in the playlist records.

In yet another form thereof, a computing device is disclosed for providing audio data files to an audio data player comprising a microcontroller coupled with data storage and a user interface, the computing device including a communication interface capable of communicating with the audio data player, the computing device having software capable of locating audio data files stored in the data storage, the audio data files having content information descriptive of the content of the audio data file; reading the content information fields for the audio data files; determining file pointer fields locating the audio data fields; sorting the file pointer fields by at least one of the content information fields; creating a playlist of records comprising the indexing fields and file pointer fields, the indexing fields indicating at least one of the location and number of playlist records related by at least one of the content information fields; and transmitting the playlist to the data storage.

In another form thereof, an audio data player is disclosed comprising a microcontroller coupled with data storage and a user interface, the microcontroller having software capable of locating audio data files stored in the data storage, the audio data files having content information descriptive of the content of the audio data file; reading content information fields for the audio data files; determining file pointer fields locating the audio data files; sorting the file pointer fields by at least one of the content information fields; and creating a playlist of records comprising the indexing fields and the file pointer fields, said indexing fields determining at least one of the location and number of playlist records related by at least one of said content information fields.

Advantageously, the disclosed method for creating audio playlists supports and enhances user interface and navigation tasks in viewing and selecting audio data files stored on a high-volume data storage device. Additionally, the present invention allows non-PC-based audio data players with limited processing power and memory to provide sophisticated user interface and navigation features that allow players to display the audio data files stored in data storage sorted by content information such as ID3 fields.

A further advantage of the present invention is that non-PC-based audio data players may access the audio content information for all audio data files stored in data storage without having to read the data directly from each audio file. Therefore, the user may quickly and easily sort and display the stored audio data files in a specified manner.

Another advantage of the present invention is creating playlist files in an audio data player that contains content information and indexing information for the purpose of reducing memory and processing power requirements, and thus the cost of producing audio data players. Yet another advantage of the present invention is that the audio playlist files maintain compatibility with standard M3U playlist files and thus may be used with other PC and non-PC-based applications.

### BRIEF DESCRIPTION OF THE DRAWINGS

The above mentioned and other features and objects of this invention, and the manner of attaining them, will become more apparent and the invention itself will be better understood by reference to the following description of one embodiment of the invention taken in conjunction with the accompanying drawings, wherein:

FIG. 1 is a block schematic diagram of a portable audio data player according to the present invention;

FIG. 2 is a top view of a portable audio data player according to the present invention;

FIG. 3 is a back view of the portable audio data player of FIG. 2;

FIG. 4 is a right side view of the portable audio data player of FIG. 2;

FIGS. 5A and 5B comprise a flowchart diagram illustrating the steps for creating audio playlist files according to the present invention; and

FIG. 6 is a plan view of a data structure for a playlist according to the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates one embodiment of the invention, in one form, and such exemplifications are not to be construed as limiting the scope of the invention in any manner.

### DETAILED DESCRIPTION OF THE INVENTION

The embodiment disclosed below is not intended to be exhaustive or limit the invention to the precise form disclosed in the following detailed description. Rather, the embodiment is chosen and described so that others skilled in the art may utilize its teachings.

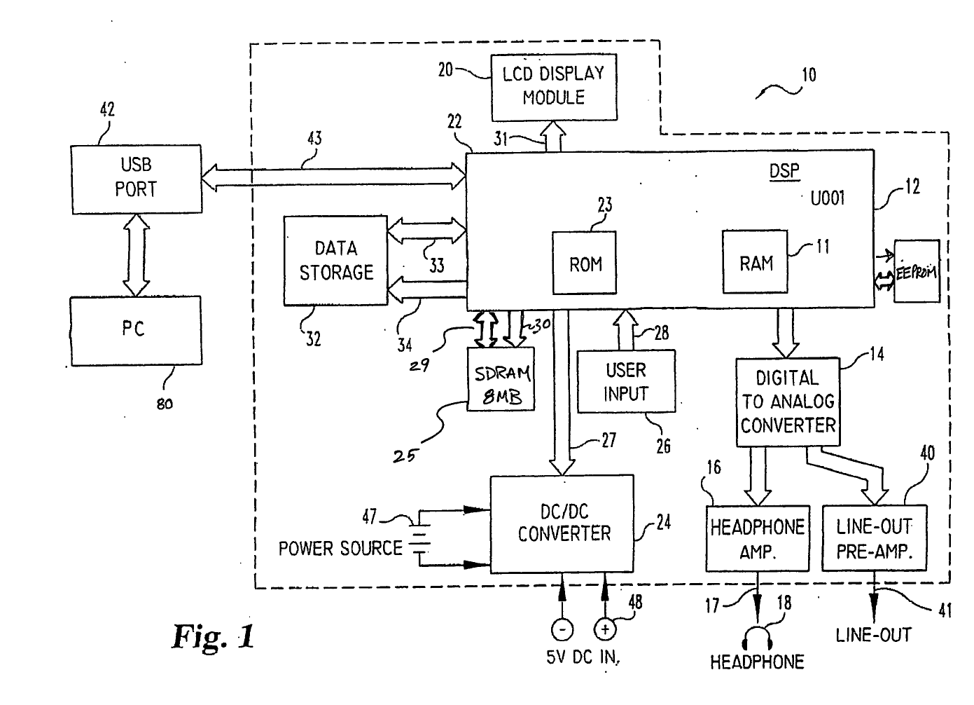

FIG. 1 shows a block diagram of portable audio data player 10 according to the present invention. The general arrangement and operation of the various elements are described hereinbelow. However, the details of the various elements of audio data player 10 are well known to those skilled in the art and will not be discussed here. Audio data player 10 comprises DSP 12 that controls the various elements and the overall operation of audio data player 10, including transferring data from data storage 32, through buffer memory 25, and decoding compressed audio files. DSP 12 includes a suitable amount of memory 23 and 11, for storing various instruction sets and programs for controlling the operation of audio data player 10.

DSP 12 may be programmed to perform a variety of signal processing functions during playback of a selected audio data file. In this case, the functions that DSP 12 performs during playback include, but are not limited to, decoding audio data files, volume control, digital sound equalization, and sample conversion. In that regard, DSP 12 includes onboard memory 11, wherein the decoder files, audio data files, equalizer mode selection, and various other required data are loaded during playback.

The decoder files comprise programs that control the decoding operations of DSP12 and the audio data files include data associated with the audio content. Both the audio data files and the decoder files are stored in data storage 32. The decoder file including the programs are transferred to DSP memory 11 from data storage 32.

Audio data and decoder programs stored in data storage 32 may be encrypted, requiring that decoding program files and audio data files be decrypted by DSP 12 using one or more decryption keys. The decryption keys may also be stored in data storage 32 and may be security linked to the particular storage device or some other coded component of audio data player 10 so that audio data files encrypted for use on a particular audio data player may only be decrypted and played by that particular audio data player.

As a selected audio data file is decoded, DSP 12 provides the decoded data stream to digital to analog converter 14. D/A converter 14 converts the digital output of DSP12 into an analog signal and provides the analog signal to headphones amplifier 16 and lineout pre-amp 40. The analog signals are amplified and provided to lineout jack 41 and headphones jack 17, both disposed on housing 13 of audio player 10.

Audio player 10 is adapted to operate with data storage 32. In this embodiment, data storage 32 is a moving data storage device, specifically a hard drive, that may be used to store various data files, including encoded audio data files, decoder files for controlling the decoding operation of DSP 12, playlist files, and computer data files, such as, for example, word processing files, presentations, and spreadsheets. A large amount of data may be readily transferred between data storage 32 and DSP 12 through data bus 33. Buffer memory 25 operates as a circular data buffer to prevent interruption of audio playback caused by a skip or other similar moving data storage device data transfer delays. Using the present invention, decoder files, playlists, and relatively large amounts of audio data may be stored on data storage 32.

In accordance with the present invention, audio data files are loaded into data storage 32 via USB port 42 from PC 80, or other similar device, using music management software that encodes the audio data files in accordance with a selected encoding format, such as MP3, or MP3 Pro, and then stores the encoded data files. Such music management software is implemented using programming methods known in the art. The music management software transmits the audio data files and appropriate decoder files to audio data player 10 across data buses 43 and 33 and into data storage 32. The music management software also generates, and modifies as necessary, a system configuration file and a file attribute table to provide information regarding the various data files and decoder files stored in data storage 32. Using the configuration file and the file attributes table, audio data player 10 is able to display audio data files sorted by various groupings on display 21, determine the correct encoding format for each audio data file, and download the appropriate decoder file for each content file in response to a user selection.

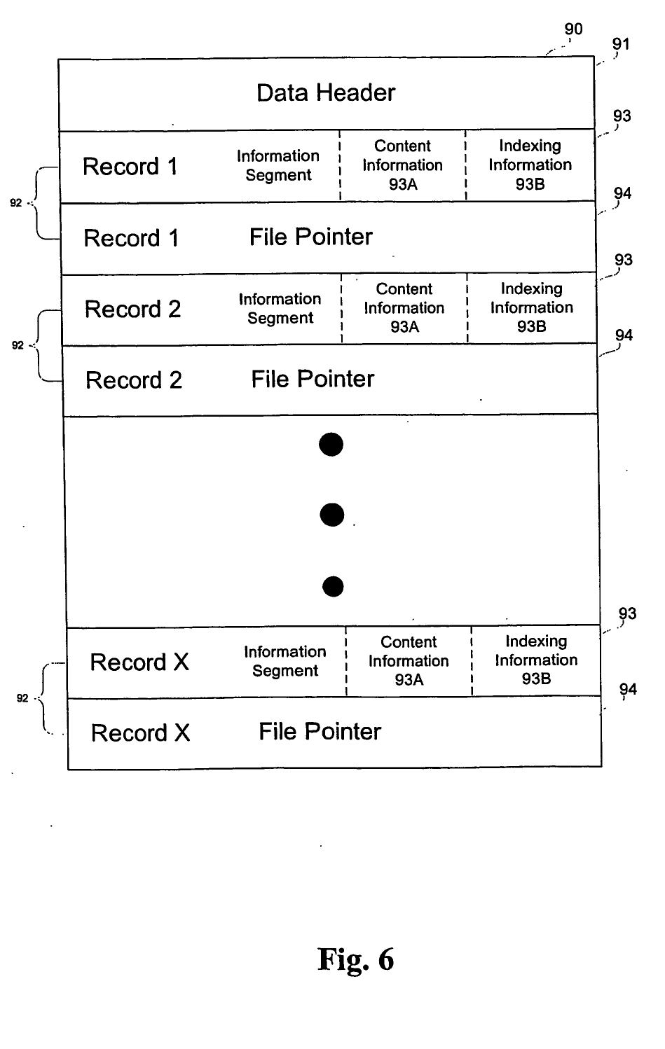

Referring to FIG. 6, an exemplary embodiment of data structure 90 according to the present invention is disclosed. Data structure 90 generally comprises data header 91, individual audio data file records 92, each record 92 including information segment 93 and file pointer 94. In the exemplary embodiment, data structure 90 is an audio playlist that includes an M3U format Data header 91 includes information for identifying the file and relevance to all the individual records 92. For example, in the exemplary embodiment, the data header has the following format:

#EXTLYRAM3U <Sorting_Field> Vx.xx

The “#EXTLYRAM3U” keyword is used to identify the file as a LyraHD system playlist file intended for use with the exemplary embodiment of audio data player 10. The Sorting_Field is enclosed by the “<” and “>” characters and contains the name of the content information field, for example, an ID3 tag field, used to sort records 92 in playlist 90. The version of the LyraHD playlist follows the Sorting_Field and is in the form of Vx.xx where x.xx represents a 3 digit decimal version number.

Information segment 93 includes a plurality of content information fields (93A) descriptive of the content of the audio data file, for example, information from ID3 tag fields, and also includes at least one indexing information field (93B) indicating the relative location of related playlist records 92. Table 1 includes the content information fields (93B) included in the exemplary embodiment and Table 2 includes the indexing information fields included in the exemplary embodiment. The sorting and indexing application according to the present invention may be configured to recognize a specific ordering of the content and indexing information. During the process of creating playlists 90, the information fields are stored in global data arrays until written to a playlist file 90. The global data arrays may be temporarily written to a memory during the profiling process.

TABLE 1

| Field Name | Description |
|---|---|
| audioInfoKeyword | #EXTLYRAINF indicates the start of a |
| | two-line audio file record |
| numberOfLevelsInTrackInfo | The number of sorted levels in a particular |
| | playlist file |
| trackIndexInPlaylist | Indicates the order of the current record in |
| | the playlist |
| charsInCurrentTrackInfo | The number of characters in the current |
| | two-line audio record |
| albumInfoField | Album name |
| artistInfoField | Artist name |
| titleInfoField | Title |
| genreInfoField | Genre |
| trackNumberInfoField | Track number in a given album |
| genericInfoField | For future expansion |

TABLE 2

| Field Name | Description |
|---|---|
| trackIndexInLevel[level] | The order of a specific entry |
| | in the current sorting level |
| totalTracksInLevel[level] | The total number of different |
| | entries in the current sorting |
| | level |
| charsToTopOfLevel[level] | Number of characters from |
| | the end of the current record |
| | to the start of the first record |
| | in the current sorting level |
| charsToNextTrackInSameLevel[level] | The number of characters |
| | from the end of the current |
| | two-line record to the start of |
| | the first record in the next |
| | entry that is in the same |
| | sorting level and shares the |
| | same parent sorting level |
| charsToPreviousTrackInSameLevel[level] | The number of characters |
| | from the end of the current |
| | two-line record to the start of |
| | the first record in the previous |
| | entry that is in the same |
| | sorting level and shares the |
| | same parent sorting level |

Playlists 90 are sorted by at least one of the content information fields 93A of Table 1. However, playlist 90 may also have multiple sorting levels and thus each record 92 may have several levels of index information fields 93B as shown and indicated in Table 2. For example, playlist 90 sorted by artist may contain three sorting levels. The first sorting level refers to all audio data files sorted by artistInfoField. The second sorting level groups all files by a particular artist and sorts each group by albumInfoField. The third sorting level groups all files by album and sorts each group by either the value of the trackNumberInfoField or the value of the titleInfoField. Although the exemplary embodiment includes five sorting levels, additional content information 93A and indexing information 93B fields and sorting levels may be used as desired in accordance with the present invention.

Indexing information fields 93B provide quick and memory-efficient browsing of related playlist records 92. The indexing information fields 93B support display groupings for browsing and navigation of various sorting levels. Indexing information 93B also defines the number of records included at a given sorting level and the relative location of next and previous records in the same sorting level and the relative location of the first record in the current grouping of the current sorting level. The indexing information fields 93B shown in Table 2 are exemplary, and may include other fields that provide browsing and navigation of the sorted playlist 90 with minimal memory and record 92 search time.

In the exemplary embodiment, the data structure of playlist 90, shown in FIG. 6, includes data written in the M3U format. Specifically, file pointer segment 94 includes data written in typical M3U format and may provide absolute or relative path locations of the audio data file associated with playlist record 92. In the exemplary embodiment, a relative path location is provided so that playlist 90 is transportable between devices. Information segment 93 containing content information fields 93A and indexing information fields 93B that include an M3U comment format, specifically the first character of the line being a # character. Additionally, data header 91 also includes an M3U comment format. Using the comment field format advantageously allows playlist 90 to remain compatible with other devices and software that utilize M3U playlist files.

Music management software that encodes and transmits the audio data files may also create and transmit playlist files 90 into data storage 32 via USB port 42 from a PC or other similar computing device. Such playlists generally use an M3U format that is similar to the data structure disclosed above and in FIG. 6; however, the data structure likely consists of records 92 containing only file pointer segments 94, and thus lack information segment 93 as disclosed above.

The present invention includes a method of creating audio playlists 90 based on the audio data file contents of data storage 32 such as, for example, a hard drive. In the exemplary embodiment, the method is executed by a software application known as the Lyra Profiler. The Profiler may be a stand-alone executable application in PC 80, a software module for use as a plug-in with existing music management software in PC 80, or a software module in audio data player 10.

The Profiler generally searches data storage 32 for all audio data files matching a specific criteria, such as MP3 files, and obtains content information from each file such as, for example, ID3 tag information, and creates various audio playlists 90, each sorted according to different content information, for example, artist, album, title, genre, and filename. If the software was executed in PC 80, playlists 90 are then transferred to audio data player 10 containing data storage 32. The generated playlists 90 include the content information fields 93A and indexing information fields 93B disclosed in Tables 1 and 2 and discussed above. The playlists 90 may advantageously be used for navigating and browsing available audio data files in audio data player 10, thereby eliminating the time and memory intensive task of accessing individual audio data files to browse and navigate content information for a predetermined sequence of the audio data files.

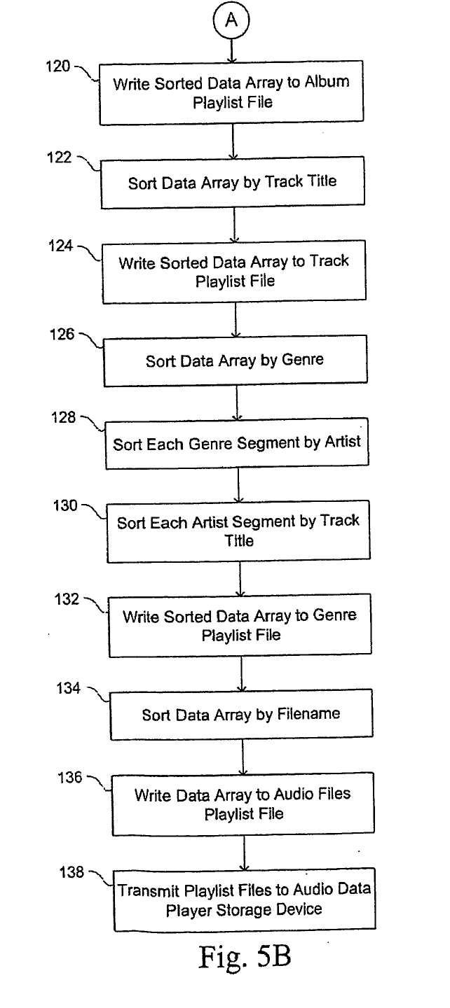

FIGS. 5A and 5B show a flowchart illustrating the steps of profiling and creating audio playlist 90 in audio data player 10 in accordance with an exemplary embodiment of the present invention. In step 102, the Profiler attempts to detect available data storage devices, such as data storage 32 or any data storage included in PC 80, for profiling. Data storage 32 may include hard drives, or other moving data storage media, or solid state memory devices. In the exemplary embodiment, hard drives available in PC 80 or in audio data player 10 may be profiled. The Profiler software may determine what available data storage device to profile, or the user may select which devices to profile. Additionally, specific folders or paths in data storage 32 may be selected for profiling.

In step 104, the selected data storage is scanned in order to locate all available audio data files. The step may be limited to locating all audio data files using a particular criteria, for example, all MP3 files. Information about the files, such as the filenames and locations and the number of files, is stored in a variable for later use and to provide status information to the users through the user interface about the progress of the profiling.

In step 106, content information is read for each audio data file for a given data storage device 32. For each audio data file, all or a portion of the content information 93A such as those fields listed in Table 1 may be stored in a global array. In addition, a file pointer field including the filename and extension and its location or path relative to the audio playlist 90 is created and stored. The content information 93A is descriptive of the content of each audio data file, for example, the Profiler in the exemplary embodiment reads ID3 tag information for album, artist, title, genre, and track number. Other ID3 or non-ID3 content information may also be created and stored for each audio data file.

In step 108, the Profiler determines whether additional data storage devices were also selected for profiling. If so, profiling proceeds at step 104 on one of the other data storage devices. If not, the Profiler starts the indexing process by sorting on one or more of the content information fields 93A. For example, in step 110 the global array structure of content information fields 93A and file pointers 94 are sorted by artist. In step 112, each particular artist segment of the global array is sorted by album and each particular album grouping is sorted by track number. The sorted global array may then formatted according to the data structure shown in FIG. 6 and stored to an artist playlist file.

In step 116, the global array is sorted by album name. In step 118, each particular album grouping of the data array is sorted by track title or track number. In step 120, the sorted global array may be formatted and stored to an album playlist file.

In step 122, the global data array is sorted by track title. In step 124, the sorted global data array may be formatted and stored to a track title playlist file.

In step 126, the global data array is sorted by genre. In step 128, each particular genre segment is sorted by artist. In step 130, each particular artist segment is sorted by track title or track number. In step 132, the sorted global data array may be formatted and stored to a genre playlist file.

In step 134, the global data array is sorted by filename. In step 136. the sorted global data array may be formatted and stored to an audio files playlist file.

If steps 102-136 were completed in PC 80 or other computing device, then in step 138, the generated playlist files would be transmitted to audio data player 10 storage device 32.

While the above profiling is proceeding, status information regarding the steps in progress of the above method may be displayed to the user via display 21 on audio data player 10, or a display device of PC 80.

For the embodiment of the present invention which executes software in audio data player 10, detection that data storage 32 contents have changed, for example, the number of free bytes available changes, may reinitiate the above profiling method or may prompt a user with a message that data storage 32 contents may have changed and new profiling may be needed. For example, if an audio data file is added or deleted from data storage 32, the option of initiating the profiling process and creating new playlists 90 may be presented to the user. In addition, to support monitoring of device contents, profiling may include the creation of a file in data storage 32 indicating the number of free bytes available or some other status indicator that may be used for determining a change in the audio data files stored in data storage 32.

In the exemplary embodiment, playlists 90 having content and indexing information 93 stored in M3U comment fields are generated by a software application. The application, referred to as the Profiler, may be implemented in PC 80 connected to audio data player 10, or as part of the software in non-PC-based audio data player 10. The Profiler software locates each available audio data file stored in data storage 32 and reads its content information, for example, ID3 tag fields in MP3 files. The software Profiler then creates several M3U playlists 90 including content and indexing information 93. Each playlist 90 is sorted by one of the content information fields 93A, for example, title, artist, genre, album, and filename. Using one playlist 90 for each content information sorting field reduces the memory and processing power requirements of audio data player 10 required to display the available audio data files in specific orders and groupings.

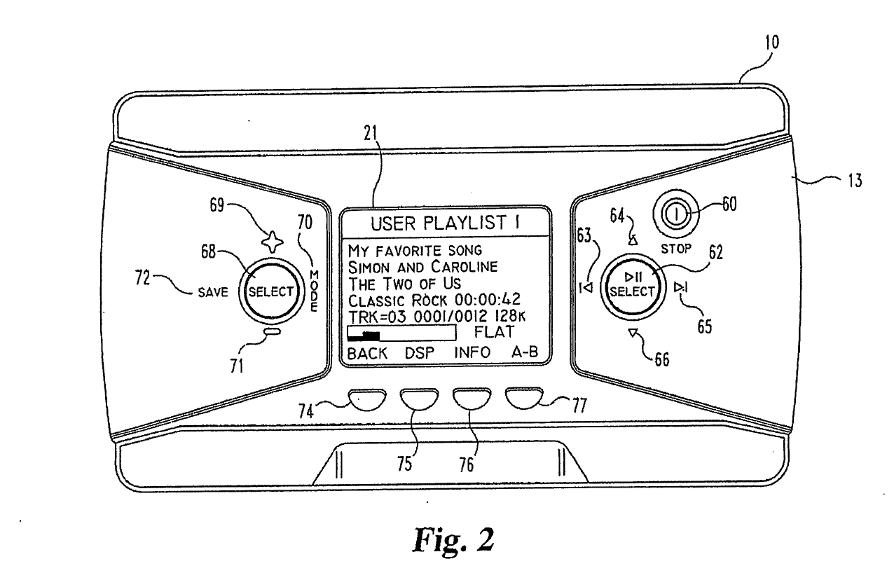

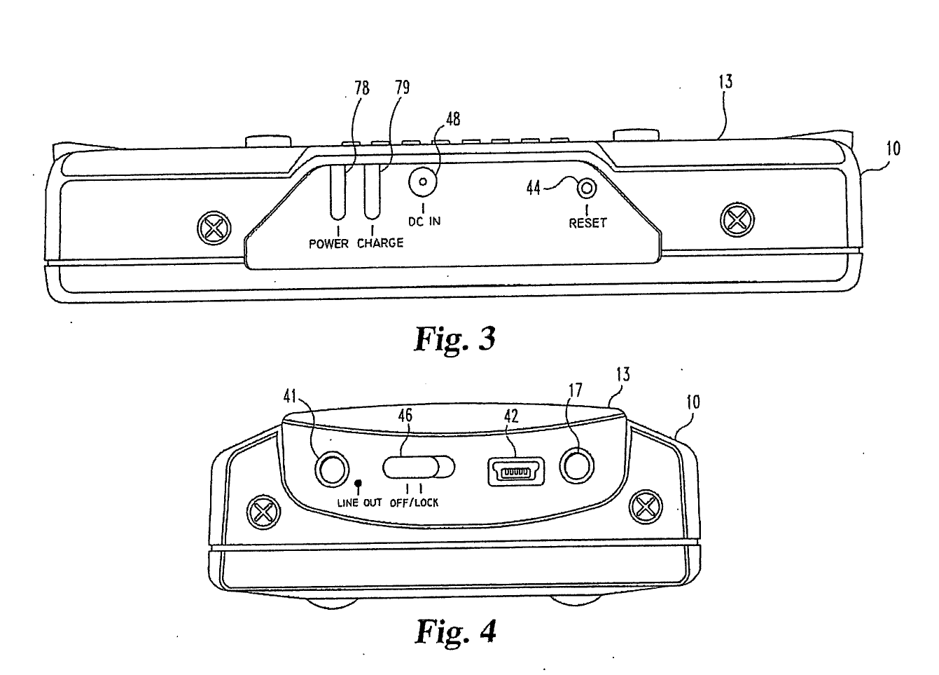

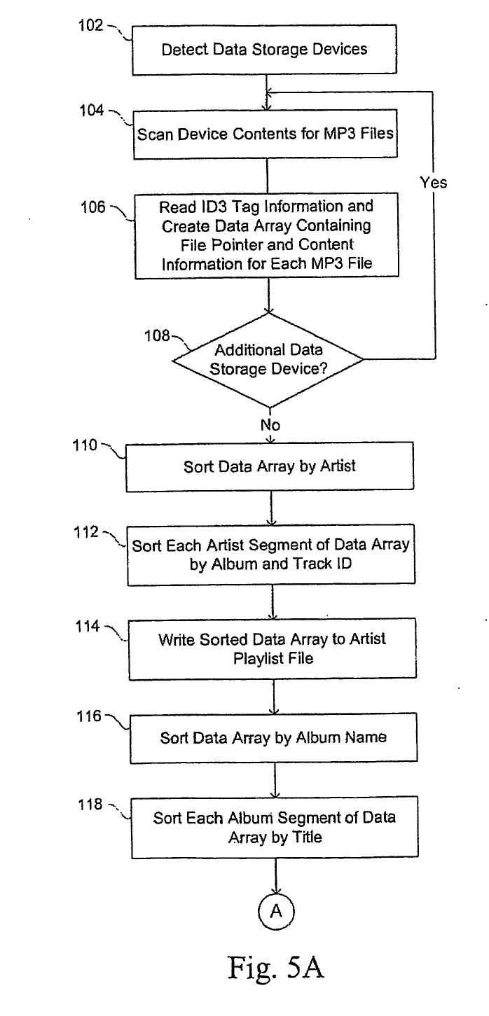

FIGS. 2-4 illustrate an exemplary embodiment of the displays, buttons, switches, indicators, and ports which may be disposed on housing 13 of audio data player 10. Referring to FIG. 2, user input 26 comprises a plurality of buttons 44 (FIG. 3), 46 (FIG. 4), and 60-77 disposed on housing 13 of audio data player 10 for allowing a user to sort and select particular audio data files for playback, and to control playback settings. User input 26 may also comprise other input devices known in the art, for example, keyboard, voice activated touch pad, and touch screen input devices. Two multi-way switches comprise buttons 62-66 and 68-72. Soft keys 74-77 are multi-function buttons whose function change for various user interface menu displays. Audio data player 10 also includes display 21 disposed on housing 13. Display 21 displays the audio data files and playlists stored in data storage 32, the function of soft keys 74-77, and various status information associated with audio data player 10, such as the playback status shown in FIG. 2 and the top-level menu shown in FIG. 5.

Referring again to FIG. 2, STOP/POWER button 60 allows the user to stop playback and to turn audio data player 10 on and off. PLAY/PAUSE button 62 allows the user to start playback and to pause playback. Left arrow button 63 allows a user to move a highlight left when using the menu, and to skip back to the previous audio data file or scan backward in the present audio data file when playing music. The right arrow button 65 allows the user to move a highlight right when using the menu, skip forward to the next audio data file, and scan forward in the current audio data file when playing music. Up arrow button 64 allows the user to move the highlight up when using the menu. Down arrow button 66 allows the user to move the highlight down when using the menu.

Referring still to FIG. 2, SELECT button 68 allows the user to select a highlighted item. Volume up button 69 increases the playback volume level for headphones 18 and volume down button 71 decreases the volume level. MODE button 70 allows the user to select a particular playback mode, including NORMAL, REPEAT, REPEAT ONE, REPEAT ALL, SHUFFLE, and REPEAT ALL SHUFFLE. SAVE button 72 allows a user to create a new playlist or add audio data files to an existing playlist. Soft keys 74-77 select the menu item that appears just above each button at the bottom of display 21.

Referring to FIG. 3, POWER indicator 78 lights when audio data player 10 is on. CHARGE indicator 79 lights when the power source 47 is charging. In the exemplary embodiment, power source 47 is a rechargeable battery pack. DC IN jack 48 provides 5 volt DC from an AC adapter to power audio data player 10 and recharge power source 47. RESET button 44 allows the user to reset all of the audio data player settings to the factory defaults.

Referring now to FIG. 4, OFF/LOCK switch 46 allows the user to make buttons 60-77 inactive when switch 46 is slid to the locked position. LINE OUT jack 41 allows a user to connect the audio data player to a separate audio system. Headphones jack 17 allows the user to play the decoded audio on headphones 18. USB port 42 provides connection of audio data player 10 to a PC or other similar device using a USB cable.

When the user selects a particular audio data file for playback via user input, DSP 12 loads the appropriate decoder file associated with the selected audio data file from data storage 32 into DSP memory 11. Referring again to FIG. 1, DSP 12 then streams the selected audio data file along buses 33 and 29 into DSP12, using buffer memory 25 as a skip-protection buffer.

After streaming of the selected audio data file begins, DSP 12 decodes the audio data file using the associated decoder file. The decoder files stored in data storage 32 allow audio player 10 to be adapted to process the various encoding formats associated with the audio data files stored in data storage 32. In effect, portable audio player 10 is software upgraded, as necessary, by the decoder files stored in data storage 32 when the user selects a particular audio data file stored in data storage 32.

After powering up, DSP 12 of audio data player 10 loads the system configuration file from data storage 32. DSP 12 identifies the various file formats that need to be supported for the data files stored in data storage 32. The configuration file also includes information that equates the file extension of the audio data files with particular decoder files stored in data storage 32. If the configuration file is valid, DSP 12 reads the file attribute table stored in data storage 32 and causes display 21 to display a menu-driven listing of the file/folders stored in data storage 32.

The main menu displayed on display 21 allows the user to navigate and display audio data files according to groupings or identifying characteristics, such as, for example, artist, album, title, genre, playlist, and all audio data files. From the main menu, the user may operate user input 26, as described above, to navigate sorted lists and select a desired one of the displayed audio data files or playlists for playback.

When an audio data file or playlist is selected for playback, DSP 12 perform a number of steps, including several concurrent steps, to provide audio playback. First, DSP 12 identifies and transfers the corresponding decoder file from data storage 32 to DSP memory 11. For example, if the user selects an MP3 file, DSP 12 transfers the MP3 decoder file from data storage 32 to memory 11. The MP3 decoder file is used to control the decoding operation of DSP 12.

DSP 12 begins streaming the selected audio data file from data storage 32 to buffer memory 25. DSP 12 uses the decoder file to decode and decrypt, if applicable, the audio data file in buffer memory 12 in accordance with the appropriate encoding format. The decoded audio data is provided to D/A converter 14 and headphone amp 16 and line out pre amp 40 for reproduction.

In the present embodiment, the necessary decoder files are stored in data storage 32 along with the audio data files. As such, audio player 10 may be updated to play different encoding formats by software updating of the DSP via decoder files stored along with the audio data files in data storage 32. Thus, audio data player 10 is capable of playing back data files encoded using a variety of encoding formats, including encoding formats that become available in the future.

During playback display, shown in FIG. 2, displays various information about the audio data file and the audio data player settings. For example, display 21 in FIG. 2 shows the filename, artist name, album title, genre, current track being played out of total files being played, volume level indication, elapsed play time of audio data file, playback mode indication, bit rate, and selected DSP mode selection.

In the exemplary embodiment, suitable DSP 12 include, but are not limited to, TMS 320DA250 manufactured by Texas Instruments Inc., of Dallas, Tex. Associated with DSP 12 is memory 23, in this case, 48 KB of ROM, and buffer memory 25 comprising 8 MB of RAM, providing 7 minutes of buffered play time at 128 kbps and 14 minutes of buffered play time at 64 kbps. DSP 12 also includes associated memory 11, in this case 64 KB of RAM. Suitable hard drives for data storage 32 include, but are not limited to, Microdrive™ manufactured by IBM Corporation of Armonk, N.Y. A 10 GB hard drive, for example, provides approximately 150 hours of audio at MP3 bit-rate of 128 kbps, or 300 hours at a bit-rate of 64 kbps.

It will be apparent to those skilled in the art that although the present invention has been described in terms of an exemplary embodiment, modifications and changes may be made to the disclosed embodiment without departing from the essence of the invention. For example, although the present invention has been described with reference to data storage 32 that is fixedly disposed within audio player 10, the present invention may be implemented using flash memory, another fixed storage device, optical device, or a memory card that is adapted to be removably coupled to audio player 10, wherein the decoder program and audio data files are loaded onto the memory card by the music management software. Also, it is herein recognized that the present feature of loading the appropriate decoder programs and the audio data files may be implemented in the music management software using any one of a number of conventionally known programming methods, or combination of programming methods. Also, although the above is described in reference to an audio data player, the present invention may be extended to any portable data processing device, for example, video display devices, wherein the data may be encoded using one of a plurality of data encoding formats. Therefore, it is to be understood that the present invention is intended to cover all modifications as defined in the appended claims.

1. A computer-readable medium having stored thereon software capable of creating a playlist of audio data file records, the software having modules for creating the playlist, comprising said modules locating audio data files stored on at least one data storage device, said audio data files having content information descriptive of the content of said audio data file; reading said content information of said audio data files; determining file pointer fields locating said audio data files; sorting said file pointer fields by at least a portion of said content information; determining indexing information fields indicating at least one of the location and number of records related by at least a portion of said content information; and storing said file pointer fields and said indexing information fields in said playlist records.

2. The computer-readable medium of claim 1, comprising said modules storing at least a portion of said content information in said playlist records.

3. The computer-readable medium of claim 2, wherein said audio data file playlist includes an M3U format and said content information and said indexing information fields are written to said playlist in M3U comment field format.

4. The computer-readable medium of claim 1, comprising the software being capable of creating a plurality of audio data file playlists, each said audio data file playlists sorted according to a different portion of said content information.

5. The computer-readable medium of claim 1, wherein said audio data files include MP3 formatted audio data and said content information includes ID3 tags, or equivalent metadata.

6. The computer-readable medium of claim 1, comprising a data processor executing the software being capable of detecting data storage devices

7. The computer-readable medium of claim 1, comprising the software being capable of detecting a change in said audio data files stored on said data storage device subsequent to indexing said audio data files and detection of said change reinitiating said software modules for creating said playlist.

8. A method for providing a playlist in an audio data player, the audio data files having content information descriptive of the content of the audio data file, comprising locating audio data files stored on at least one data storage device; reading said content information of said audio data files; determining file pointer fields locating said audio data files; sorting said file pointer fields by at least a portion of said content information; determining indexing information fields indicating at least one of the location and number of playlist records related by at least a portion of said content information; storing said file pointer fields and said indexing information fields in said playlist records.

9. The method of claim 8, comprising storing at least a portion of said content information in said playlist records.

10. The method of claim 9, wherein said audio data file playlist includes an M3U format and said content information and said indexing information fields are written to said playlist in M3U comment field format.

11. The method of claim 8, comprising creating a plurality of audio data file playlists, each said audio data file playlists sorted according to a different portion of said content information.

12. The method of claim 8, comprising detecting a change in said audio data files stored on said data storage device and rewriting at least one playlist upon detection of said change.

13. A computing device for providing audio data files to an audio data player, the audio data player comprising a DSP coupled with data storage and a user interface, said computing device including a communication interface capable of communicating with the audio data player, said computing device comprising software capable of locating audio data files, said audio data files having content information descriptive of the content of said audio data file; reading said content information for said audio data files; determining file pointer fields locating said audio data files; sorting said file pointer fields by at least a portion of said content information; creating a playlist of records comprising said indexing fields and file pointer fields, said indexing information fields indicating at least one of the location and number of playlist records related by at least a portion of said content information; and transmitting said playlist to the data storage.

14. The computing device of claim 13 comprising said software being capable of storing at least a portion of said content information in said playlist records, and the audio data player having software capable of accessing said playlist and providing said at least a portion of said content information to the user interface.

15. An audio data player comprising a DSP coupled with data storage and a user interface, comprising the DSP having software capable of locating audio data files stored in the data storage, said audio data files having content information descriptive of the content of said audio data file; reading said content information for said audio data files; determining file pointer fields locating said audio data files; sorting said file pointer fields by at least a portion of said content information; and creating a playlist of records comprising indexing fields and said file pointer fields, said indexing fields determining at least one of the location and number of playlist records related by at least a portion of said content information.

16. The audio data player of claim 15, comprising said software being capable of storing at least a portion of said content information in said playlist records.

17. The audio data player of claim 16, wherein said playlist file content information is selectively supplied to said user interface.

18. The audio data player of claim 16, wherein said playlist records include an M3U format and said content information is stored in an M3U comment field.

19. The audio data player of claim 15, wherein said software is capable of creating a plurality of audio data playlists, each of said audio data playlists sorted according to a different portion of said content information.

20. The audio data player of claim 15, wherein said software is capable of detecting a change in the contents of the data storage, detection of said change reinitiating said software for creating said sorted playlist.
